(19) United States
(12) Patent Application Publication
(10) Pub. No.: US 2020/0354207 A1
(43) Pub. Date: Nov. 12, 2020

(54) APPARATUS FOR REMOVAL OF A FRUIT WEDGE AND CAP FROM A BEVERAGE BOTTLE AND METHODS OF USE

(71) Applicants: Brendan D. Jacques, Hancock, MI (US); Shane M. Jacques, Hancock, MI (US)

(72) Inventors: Brendan D. Jacques, Hancock, MI (US); Shane M. Jacques, Hancock, MI (US)

(21) Appl. No.: 16/866,508

(22) Filed: May 4, 2020

Related U.S. Application Data
(60) Provisional application No. 62/969,735, filed on Feb. 4, 2020.
(60) Provisional application No. 62/845,551, filed on May 9, 2019.

(51) Int. Cl. B67B 7/44; B67B 7/16

(52) U.S. Cl. CPC B67B 7/44; B67B 7/16

(57) ABSTRACT

Disclosed herein are various forms of beverage tools. The beverage tools comprise a bottle cap remover portion to remove a bottle cap from a bottle and a solids remover portion for removing debris from the inside of a bottle. The solids removal portion comprises a post extending from the bottle cap remover portion. At a distal end of the post are one or more barbs extending from a lateral side of the post and swept toward the bottle cap remover portion. In one form, a rigid bottle opener is housed in a head housing from which the post extends. In another form the post and the rigid bottle opener are a single uniform part. A novel method for removing debris from a bottle using the beverage tools is disclosed.

### CROSS REFERENCE TO RELATED APPLICATIONS

This application claims priority to Provisional Patent Application No. 62/969,735 filed Feb. 20, 2020 and Provisional Patent Application No. 62/845,551 filed May 9, 2019, the entire disclosures of which are hereby incorporated by reference and relied upon.

### BACKGROUND OF THE INVENTION

### Field of the Invention

The invention relates generally to opening bottles containing beverages and methods of removing solids, and more particularly to removing parts of fruit, bottle caps, and other items from inside a beverage bottle.

### Description of Related Art

Bottle caps, cigarette butts, fruit wedges, napkins, and other garbage often get pushed into beverage bottles by those who consume beverages. This creates a problem for those who wish to return or otherwise recycle the bottles due to compliance with recycling guidelines. The residue also attracts uninvited insects and rodents to a bottle storage area. In addition, it also creates a safety hazard such as lacerations for those that might try to use a tool such as a steak knife to stick in the bottle to remove its contents, or attempt to remove the contents by vigorously shaking the bottle until the contents fly out. Of course violent shaking of a bottle can lead to projectile glass. The risks escalate even further for individuals attempting these methods after consuming alcohol. Garbage such as fruit wedges left in bottles results in smelly, moldy, and gross by products at the bottom of the bottle. What is needed are tools and methods to allow both bars and individuals a compliant, safe, and quick way to remove these disposables from the inside of beverage bottles. What is needed is a tool that also serves a dual purpose of also opening beverage bottles to eliminate the need for excess tools.

### SUMMARY OF THE INVENTION

The article of invention is a beverage tool comprising a bottle cap remover portion and a solids remover portion for removing solid debris from a bottle.

In one form, the beverage tool comprises a rigid bottle opener operable to remove a bottle cap.

In one form, the rigid bottle opener is housed within a head housing.

In one form, the beverage tool is absent of a head housing.

In one form, a post extends from said head housing.

In one form, the beverage tool is in a single part configuration whereas the bottle cap remover portion is integral with the solid remover portion.

In one form, the beverage tool is made entirely of a metal, including but not limited to steel, aluminum, and various metal alloys.

In one form, the beverage tool is made entirely of a polymer such as plastics.

In one form, the beverage tool is made from a combination of a metal and a polymer.

In one form, a post extends from the rigid bottle opener.

In one form, the post has a cross sectional profile that is substantially one of but not limited to the following: rectangular, round, square, and polygonal.

In one form, the beverage tool in an assembled configuration is generally flat and aligned in a plane A.

In one form, the beverage tool is in a single part cart configuration whereby the tool requires no assembly.

In one form, the beverage tool comprises an opposing first face and second face defining a substantially uniform thickness T.

In one form, the beverage tool is in an assembled configuration whereas it is made of an assembly of parts.

In one form, the rigid bottle opener is metal.

In one form, the rigid bottle opener is manufactured from a steel such as one of a carbon steel and a stainless steel. In one form, the beverage tool comprises a solids removal portion extending from the bottle opener portion.

In one form, the head housing and solids removal portion is a polymer.

In one form, the solids removal portion comprises the post.

In one form, the post extending from the head housing is of a length sufficient to reach below a bottle neck inside a bottle.

In one form the post comprises a frontal surface facing front, rear surface facing back, a first lateral surface and an opposed second lateral surface facing away from a midline axis.

In one form, the post comprises one or more barbs extending from the post.

In one form, the one or more barbs includes a first barb and a second barb extending from the post.

In one form, the one or more barbs extend from at least one of a first lateral surface and a second lateral surface of the post.

In one form, the first barb extends along an axis F1 and the second barb extends along an axis F2 whereas axis F1 and F2 are substantially parallel.

In one form, the first barb and second barb extend along non-parallel axes.

In one form, the bottle cap remover portion and solids removal portion are substantially flat and are aligned in plane A.

In one form, at least one of the one or more barbs are aligned in plane A.

In one form, two or more barbs are aligned in plane A.

In one form, at least one of the barbs extending from the post is angled a from a midline axis B of the beverage tool.

In one form, a is less than 45 degrees.

In one form, at least one of the first barb and second barb is swept towards the bottle cap remover portion.

In one form, a first barb is spaced distally from a second barb at a distal end of the post.

In one form, each barb terminates in a point that is at least one of sharp or blunt.

In one form, each barb comprises a proximal face facing towards the head housing.

In one form, each barb comprises a distal face facing away from the head housing.

In one form, each barb comprises a front barb face facing towards the front.

In one form, each barb comprises a rear barb face facing towards the back.

In one form, each barb is wider medially at its base and narrows towards the point.

In one form, each of the first barb and second barb point in substantially the same direction.

In one form, a relief is placed at a proximal intersection between one or more of the first barb and second barb and the post.

In one form, the relief is in the form of an arc at the medial end of a proximal face.

In one form, the post has a thickness ‘D’ and the head housing has a thickness ‘C’.

In one form, thickness ‘C’ is greater than thickness ‘D’.

In one form, the rigid bottle opener is generally flat.

In one form, the rigid bottle opener has a key shaped body.

In one form, the rigid bottle opener has an enlarged head.

In one form, the enlarged head has a first face and a second face.

In one form, an outside wall spans between the first face and second face.

In one form, an inside wall defines an oblong aperture extending between the first face and the second face.

In one form, at least one of a first tongue and a second tongue extend from the inside wall.

In one form, a first tongue and second tongue extend from the inside wall on opposing sides.

In one form, the first tongue and second tongue are aligned along midline axis B.

In one form, the first tongue and second tongue are arced.

In one form, the oblong aperture is operable with the first tongue and second tongue for removing a bottle cap.

In one form, the first tongue and second tongue are removed whereby the oblong aperture is operable to removing a bottle cap.

In one form, the oblong aperture is generally rectangular.

In one form, a leverage leg extends from an inferior end of the enlarged head and operable to provide a user finger leverage when opening a bottle.

In one form, the proximal end of the enlarged head is rounded.

In one form, one or more of the first tongue and second tongue comprise tongue depressions inset from one or more of the first face and second face.

In one form, the head housing and post are a single piece molded about the rigid bottle opener whereby the rigid bottle opener resides in an opener cavity.

In one form, the head housing comprises a first body and a second body.

In one form, the first body is integral with the post.

In one form, the first body comprises a first front surface facing the front and a first back surface facing the back.

In one form, the first body comprises a first outer surface extending on the outer periphery between the first front surface and back surface.

In one form, the first body comprises a first inner surface extending about an inner periphery between the first front surface and first back surface.

In one form, the first inner surface defines an opener aperture for access to the rigid bottle opener in an assembled configuration.

In one form, the opener cavity is defined by a platform face inset from said first front surface and a receiver face extending between the platform face and first front surface.

In one form, the opener cavity is sized and shaped to receive the rigid bottle opener therein.

In one form, a second body comprises a profile reflective of the head of the first body.

In one form, a second body is aligned and fixed to the first body.

In one form, a rigid bottle opener is sandwiched between the first body and the second body.

In one form, the second body comprises a second outer surface facing outside the second body.

In one form, the second body comprises a second inner surface defining a second clearance hole.

In one form, the second body comprises a second back surface abutting a first front surface of the first body in an assembled configuration.

In one form, the second body comprises a second inner surface defining a second clearance hole providing access to the rigid bottle opener.

In one form, the second body comprises a tab extending from a bottom end of the first body.

In one form, the tab terminates in an end stop.

In one form, the tab comprises a pair of opposing tab stops spaced from the end stop.

In one form, the tab is at least one of but limited to generally: square, rectangular, circular, and curved.

In one form, a thickened neck portion is intermediate the head housing and the post of the first body.

In one form, the neck portion comprises a neck taper towards the post.

In one form, the neck portion comprises a U-shaped terminal wall defining a terminal cavity operable for housing the tab of the second body and a portion of the leverage leg of the rigid bottle opener.

In one form, the first body, the rigid bottle opener, and the second body are aligned along complementary shapes and fixed together along axis E.

In one form, one or more of the: first barb, second barb, and post are deflectable.

In one form, a distal portion of the post terminates in a blunt end.

In one form, a method for removing debris comprises the following steps. Obtaining a bottle with solids debris that needs to be removed from inside the bottle. Obtaining a beverage tool having a bottle cap remover potion at a proximal end and a solids removal portion at a distal end. Securing the bottle in a position such that gravity causes the debris to drop towards the bottle neck. Grasping the bottle cap remover portion of the beverage tool, and inserting the post of the beverage tool into the mouth of the bottle whereby the point of at least the first barb moves at least partially past the solid debris contained in the bottle. Tilting the post whereby at least one of a first barb and second barb engage the solid debris. Retracting the beverage tool such that the solid debris engaged with the barb is removed through the neck and mouth of the bottle.

### BRIEF DESCRIPTION OF THE SEVERAL VIEWS OF THE DRAWINGS

These and other features and advantages of the present invention will become more readily appreciated when considered in connection with the following detailed description and appended drawings, wherein each drawing is according to one or more embodiments shown and described herein, and wherein:

FIG. 1 depicts a perspective view of a beverage tool having a head housing;

FIG. 2 depicts an exploded view of the beverage tool in FIG. 1;

FIG. 3 depicts a partial close-up exploded view of the head housing and rigid bottle opener of FIG. 1;

FIG. 4 depicts a front view of the beverage tool of FIG. 1;

FIG. 5 depicts a first lateral view of the beverage tool of FIG. 1;

FIG. 6 depicts a partial frontal close-up view of the first and second barb;

FIG. 7 depicts a diagram of the relation of the head housing integrating both the first body and post, and seating the bottle cap remover portion therein;

FIG. 8 depicts the use of a beverage tool removing debris from the inside of a bottle;

FIG. 9 depicts a flow chart illustrating the steps to use a beverage tool for removing debris from a bottle;

FIG. 10A depicts a rear perspective view of a beverage tool;

FIG. 10B depicts a front perspective view of the beverage tool of FIG. 10A;

FIG. 10C depicts a front perspective view of the beverage tool of FIG. 10A;

FIG. 10D depicts a rear view of the beverage tool of FIG. 10A;

FIG. 10E depicts a front view of the beverage tool of FIG. 10A;

FIG. 10F depicts an exploded front view of the beverage tool of FIG. 10A;

FIG. 11A depicts a front view of the beverage tool of FIG. 10A with first and second trademark flat;

FIG. 11B depicts a first lateral perspective view of the beverage tool of FIG. 10A with trademark flats;

FIG. 11C depicts a rear view of the beverage tool of FIG. 10A illustrating sample dimensions.

### DETAILED DESCRIPTION OF SELECTED EMBODIMENTS OF THE INVENTION

Select embodiments of the invention will now be described with reference to the Figures. Like numerals indicate like or corresponding elements throughout the several views and wherein various embodiments are separated by letters (i.e. 100, 100B, 100C). The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

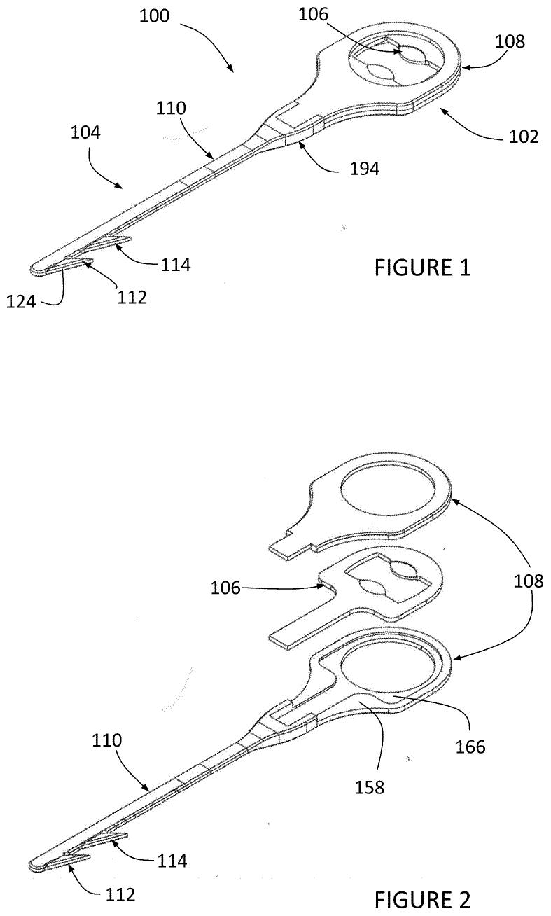

FIG. 1 illustrates a preferred embodiment of a beverage tool 100 comprising a bottle cap remover portion 102 and a solids remover portion 104. The bottle cap remover portion 102 is operable to remove a bottle cap from a bottle by wedging the cap off the bottle as known in the prior art.

In this embodiment as illustrated in FIGS. 1-6, a rigid bottle opener 106 preferably made of metal is housed within a head housing 108. A post 110 extends from head housing 108 at a distal end. Post 110 terminates distally at a blunt end 198. In this embodiment, post 110 comprises a frontal face 115 facing front, a rear face 117 facing back, a first lateral surface 111 and an opposed second lateral surface 113 facing away from an midline axis. Here, first barb 112 and second barb 114 extend from first lateral surface 111.

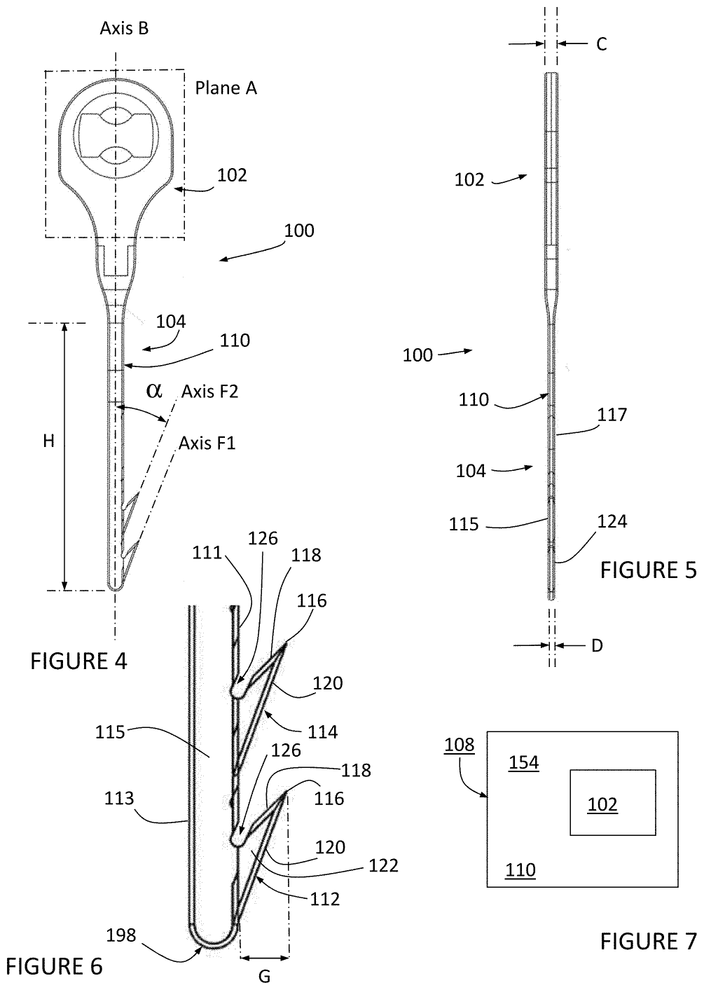

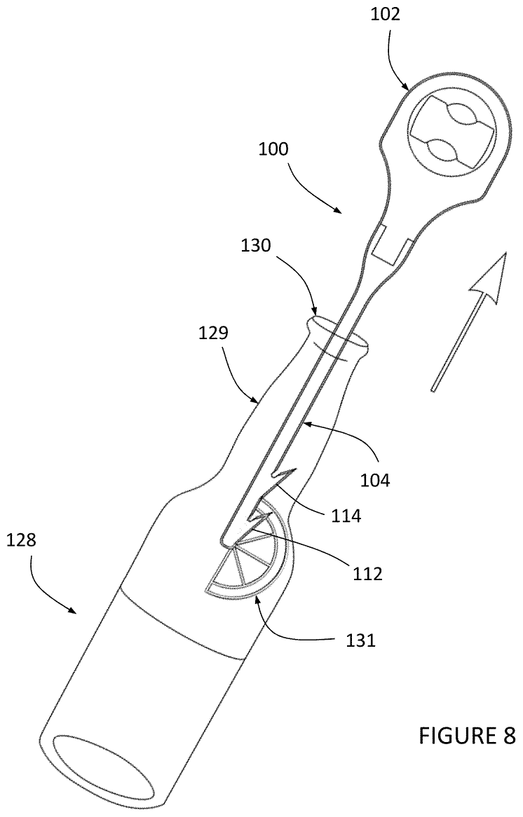

The beverage tool 100 in an assembled configuration is illustrated in FIGS. 1 and 4 and is generally flat and aligned in a plane A. Beverage tool 100 comprises a solids removal portion 104 preferably made of a polymer (although other materials may be used) extending from bottle cap remover portion 102. The solids removal portion 104 comprises post 110 extending from head housing 108 and preferably of a length sufficient to reach below a bottle neck 129 inside a bottle 128. In preferred embodiments, the portion of the post 110 that is sufficiently narrow to fit into the mouth of a common beverage bottle (length H, FIG. 4) is between 3 inches and 6 inches long and comprises one or more barbs extending from the post which may include a first barb 112 and a second barb 114 etc. In alternative embodiments, post 110 may be of lengths outside the 3-6 inch range. For example the post maybe of sufficient length to reach the bottom of a bottle (i.e. >6 inch). Although not required, the first barb and second barb are parallel as illustrated in FIG. 4. In this embodiment, at least one of the one or more of the barbs are aligned in a plane such as plane A in FIG. 4 with the bottle cap remover portion 102. Also illustrated, at least one of the barbs extending from the post is angled a from a midline axis B of the beverage tool. In preferred embodiments, a is less than 45 degrees. As illustrated here, the first barb 112 is spaced from the second barb 114 at a distal end of post 110. In this embodiment, point 116 of the barb is laterally spaced a distance G from the post between 0.125 inch and 0.375 inch, however in some embodiments distance G may be greater or less than these values. In one embodiment, distance G is 0.25 inch.

In this embodiment, each barb (112, 114) terminates in a point and each barb comprises a proximal face 118 facing towards head housing 108 and a distal face 120 facing away from head housing 108. In addition, each barb comprises a front barb face 122 facing towards the front and a rear barb face 124 facing towards the back. Each barb is preferably wider medially at its base and narrows towards the point 116. As illustrated in FIG. 4, first barb 112 and second barb 114 point in the same direction. A relief 126 is placed at a proximal intersection between one or more of the first barb 112 and second barb 114 and post 110. The relief 126 is in the form of an arc at the medial end of proximal face 118.

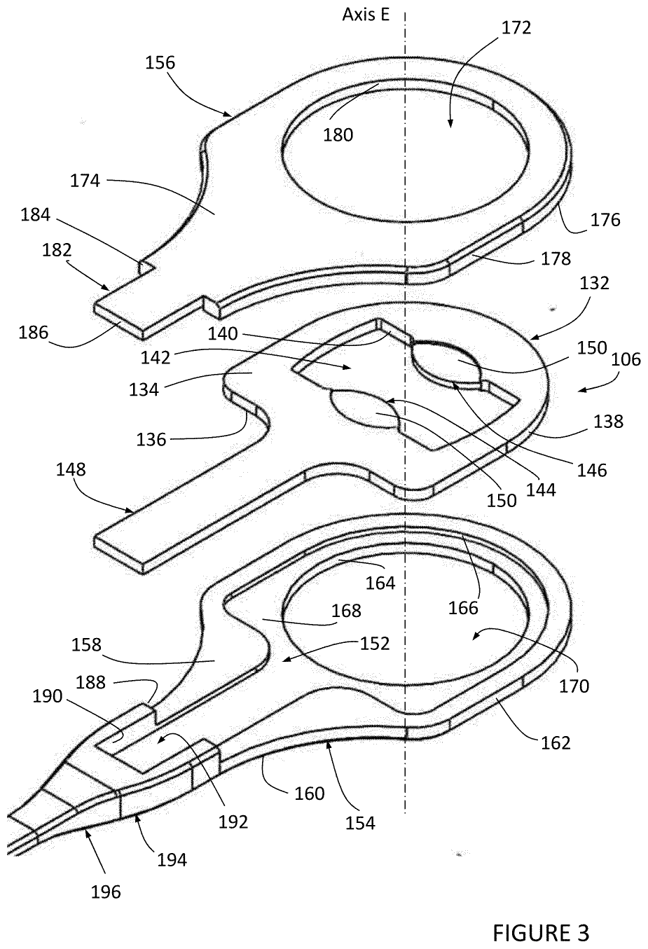

As illustrated in the FIG. 5 embodiment, post 110 has a thickness ‘D’ whereas the head housing 108 has a thickness ‘C’. As noted C>D in this embodiment. As illustrated in FIG. 3, rigid bottle opener 106 is generally flat and may be made of metal having a key shaped body and an enlarged head 132. In this embodiment, the enlarged head 132 has a first face 134 and a second face 136 opposite the first face. An outside wall 138 spans between the first face 134 and second face 136. An inside wall 140 defines an oblong aperture 142 extending between the first face 134 and the second face 136. A first tongue 144 and a second tongue 146 extend from inside wall 140 on opposing sides and are aligned along midline axis B. In preferred embodiments, first tongue 144 and second tongue 146 are arced. The oblong aperture 142 is operable with the first tongue 144 and second tongue 146 for removing a bottle cap. In alternative embodiments, the first tongue and second tongue are removed whereby the oblong aperture is operable to removing a bottle cap. In one embodiment as illustrated here, the oblong aperture is generally rectangular. A leverage leg 148 extends from an inferior end of enlarged head 132 and operable to provide a user finger leverage when removing a cap to open a bottle. The proximal end of the enlarged head 132 may be rounded. One or more of the first tongue 144 and second tongue 146 comprise tongue depressions 150 inset from one or more of the first face 134 and second face 136. In alternative embodiments, the head housing 108 and post 110 are a single piece molded about the rigid bottle opener 106 whereby the rigid bottle opener resides in an opener cavity.

In the embodiment illustrated in FIGS. 1-3, the head housing 108 comprises a first body 154 integral with post 110. First body 154 comprises a first front surface 158 facing the front and a first back surface 160 facing the back. First body 154 further comprises a first outer surface 162 extending on the outer periphery between the first front surface 158 and first back surface 160. First body 154 comprises a first inner surface 164 extending about an inner periphery between the first front surface 158 and first back surface 160. First inner surface 164 defines a first clearance hole 170 for access to the rigid bottle opener 106.

An opener cavity 152 is defined by a platform face 168 inset from first front surface 158 and a receiver face 166 extending between platform face 168 and first front surface 158. The opener cavity 152 is sized and shaped to receive the rigid bottle opener 106 therein. Second body 156 comprises a profile reflective of the head of first body 154. In an assembled configuration, second body 156 is aligned and fixed to first body 154 with rigid bottle opener 106 sandwiched between first body 154 and second body 156.

Further to FIG. 3, second body 156 comprises a second outer surface 178 facing outside second body 156. Second body 156 comprises a second inner surface 180 defining a second clearance hole 172 providing access to enlarged head 132 of rigid bottle opener 106. Second body 156 comprises a second back surface 176 abutting first front surface 158 of first body 154 in an assembled configuration. In addition, second body 156 comprises a second inner surface defining a second clearance hole 172 again providing access to rigid bottle opener 106. Second body 156 comprises a tab 182 extending from a bottom end of the second body and terminates in an end stop 186. Here, tab 182 comprises a pair of opposing tab stops 184 spaced from the end stop 186 for abutting opposed bump stops 188 on first body 154. Tab 182 is illustrated as generally square but may assume other shapes such as rectangular, circular, and curved. A thickened neck portion 194 is intermediate head housing 108 and post 110 of first body 154. Neck portion 194 comprises a neck taper 196 narrowing when approaching the post. In this embodiment, neck portion 194 comprises a U-shaped terminal wall 190 defining a terminal cavity 192 operable for housing tab 182 of the second body 156 and a portion of the leverage leg 148 of the rigid bottle opener 106. As illustrated in FIG. 3, first body 154, rigid bottle opener 106, and second body 156 are aligned along complementary shapes and fixed together along axis E. In preferred embodiments, one or more of the: first barb 112, second barb 114, and post 110 are deflectable. This may assist in entering the bottle neck and avoid injury to a user.

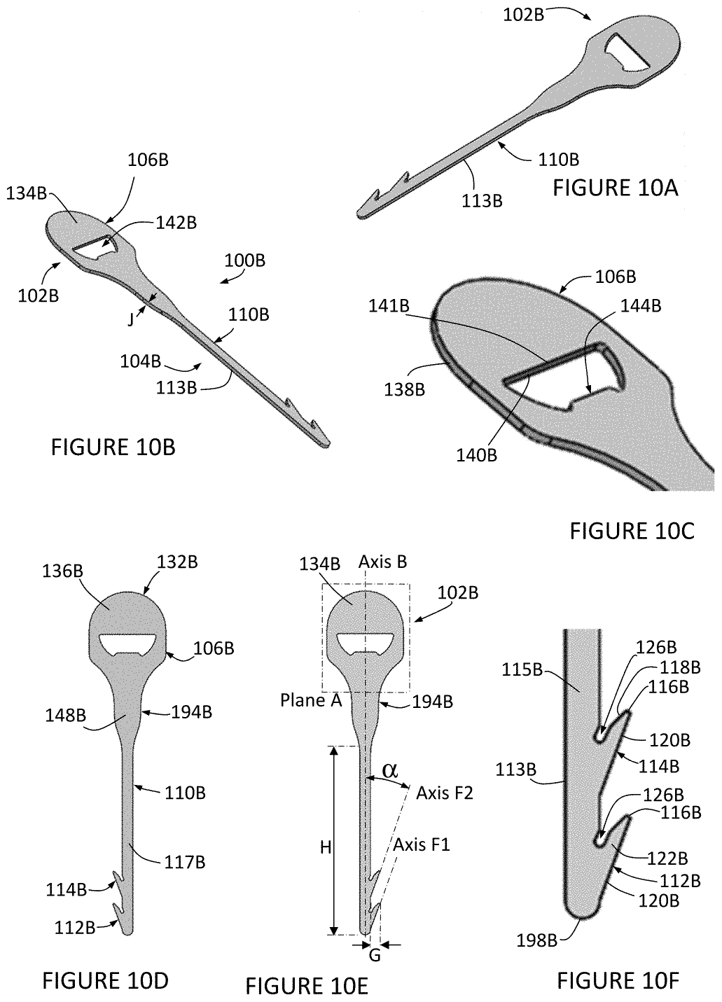

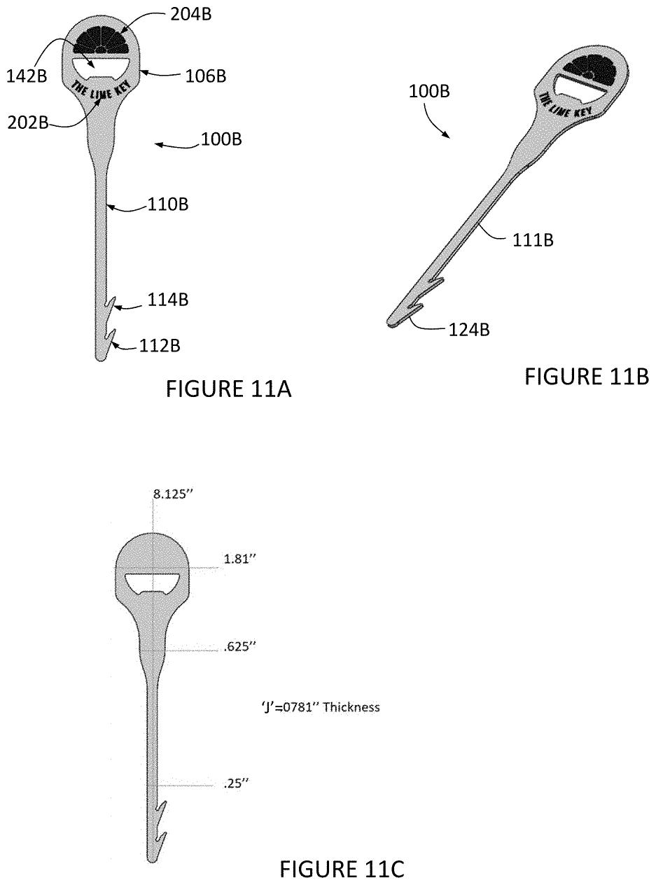

FIGS. 10A-10F and FIGS. 11A-11C represent an alternative embodiment of a beverage tool 100B whereas a bottle cap remover portion 102B and a solids removal portion 104B are manufactured as a single part. For example, in one embodiment the beverage tool is manufactured from a single piece of metal such as for example, steel or stainless steel. Therefore, the bottle cap remover portion 102B inherently comprises a rigid bottle opener 106B optionally absent of a head housing. The rigid bottle opener 106B comprises an enlarged head 132B having a substantially flat first face 134B opposed to a substantially flat second face 136B and defined by an outside wall 138B extending between the first face and second face. An oblong aperture 142B substantially centered in the rigid bottle opener 106B is defined by inside wall 140B which also extends between the first face 134B and second face 136B.

The oblong aperture in this embodiment comprises a first tongue 144B extending into the oblong aperture 142B from a distal side and is opposed by a substantially flat portion 141B of the inside wall 140B on the proximal side. As will be recognized by those skilled in the art, the profile of the oblong aperture may assume a variety of shapes all functional for removal of a bottle cap.

In this embodiment, a neck portion 194B extends distally from the enlarged head 132B and is utilized as a leverage leg 148B providing a strong broad surface for the user to leverage off a beverage cap. Extending distally from neck portion 194B generally along Axis B is post 110B terminating at blunt end 198B. In this embodiment, post 110B comprises a frontal face 115B facing front, a rear face 117B facing back, a first lateral surface 111B and an opposed second lateral surface 113B facing away from an midline axis (Axis B).

As before, one or more barbs such as first barb 112B and second barb 114B extend at an angle α from axis B which is typically less than 45 degrees. First barb 112B extends along Axis F1 whereas second barb 114B extends along Axis F2 which in this embodiment are generally parallel although may be non-parallel. The barbs extend outwardly from Axis B a distance G perpendicular from Axis B and terminating at point 116B. Facing distally on the barbs is distal face 120B and facing proximally on the barbs is proximal face 118B. The barbs in this embodiment comprise front barb face 122B and a rear barb face 124B that are substantially planar with respective first face 134B and second face 136B of the bottle cap remover portion 102B and post 110B. A relief 126B is present in the form of a rounded intersection between proximal face 118B of the post(s) and first lateral surface 111B of post 110B. In this embodiment, post 110B extends a distance ‘H’ from neck portion 194B. FIG. 11C illustrates preferred measurements of one embodiment. Note in this embodiment, both barbs extend uni-laterally from post 110B.

As illustrated in FIGS. 11A and 11B, beverage tool 100B comprises a first trademark flat 202B and a second trademark flat 204B. First trademark flat 202B comprises a substantially flat surface located just distal and adjacent to oblong aperture 142B on which an associated first trademark symbol 206B can be placed (i.e. ‘THE LIME KEY’). Similarly, second trademark flat 204B comprises a substantially flat surface located just proximal and adjacent to oblong aperture 142B also on which a second associated trademark symbol (i.e. ‘lime slice’ icon) can be placed. The trademark symbol may be applied by a variety of methods not limited to etching, stamping, and adhesives. In this embodiment, first trademark flat 202B comprises text but may comprise text or image thereon, whereas second trademark flat 204B comprises an image but may comprise text or image thereon. In preferred embodiments, the second trademark flat 204B comprises an image of a citrus fruit thereon. Both images in FIGS. 11A and 11B are the trademark property of the inventor. FIG. 11C provides approximate dimensional considerations for a preferred embodiment however these dimensions can be varied and remain within the scope of the invention.

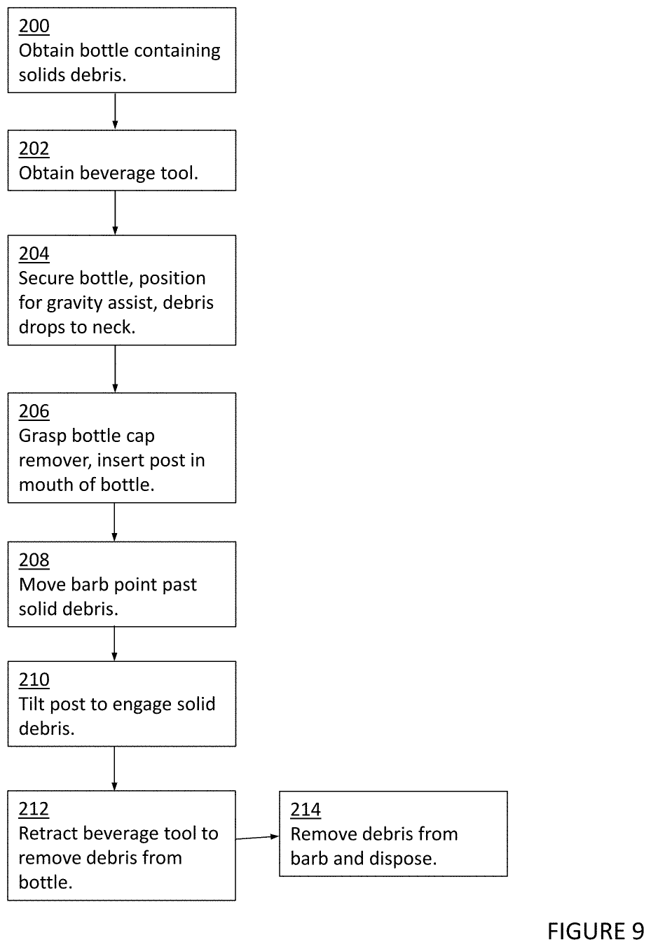

In one form, a method for removing debris comprises the following steps as illustrated in FIG. 9. Obtaining a bottle with solids debris 200 that needs to be removed from inside the bottle. Obtaining a beverage tool having a bottle cap remover potion at a proximal end and a solids removal portion at a distal end 202. Securing the bottle in a position such that gravity causes the debris to drop towards the bottle neck 204. Grasping the bottle cap remover portion of the beverage tool, and inserting the post of the beverage tool into the mouth of the bottle 206 whereby the point of at least the first barb moves at least partially past the solid debris contained in the bottle 208. Tilting the post whereby at least one of a first barb and second barb engage the solid debris 210. Retracting the beverage tool such that the solid debris engaged with the barb is removed through the neck and mouth of the bottle 212. Remove the debris from the barb and dispose of the solid debris 214.

It is noted that the terms “substantially” and “about” and “generally” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

The foregoing invention has been described in accordance with the relevant legal standards, thus the description is exemplary rather than limiting in nature. Variations and modifications to the disclosed embodiment may become apparent to those skilled in the art and fall within the scope of the invention.

1. A beverage tool comprising:
a bottle cap remover portion operable for removing a bottle cap;
a solids removal portion operable for removing debris from inside a bottle;
said bottle cap remover portion comprising a rigid bottle opener;
said rigid bottle opener formed between a substantially flat first face and a substantially flat second face;
an outside wall extending between said first face and said second face along an outside perimeter of said rigid bottle opener;
an inside wall extending between said first face and said second face;
said inside wall defining an oblong aperture within said rigid bottle opener;
said solids removal portion comprising a post extending along an axis away from said bottle cap remover portion;
a first barb extending from a distal end of said post; and
said first barb swept towards said bottle cap remover portion.

2. The beverage tool of claim 1 further comprising:
a substantially flat frontal face extending along the length of said post;
a substantially flat rear face extending along the length of said post;
said frontal face and said rear face substantially parallel and opposed to each other on each side of said post; and
whereas said frontal face is parallel to said first face; and
whereas said rear face is parallel to said second face.

3. The beverage tool of claim 1 further comprising:
a first tongue; and
said first tongue extends into said oblong aperture from at least one side of said inside wall.

4. The beverage tool of claim 3 whereas said first tongue faces proximally.

5. The beverage tool of claim 1 further comprising:
a second barb extending from said post;
said second barb spaced from said first barb along said axis; and
said second barb swept towards said bottle cap remover portion.

6. The beverage tool of claim 5 whereas said first barb and said second barb are positioned at a distal end of said post.

7. The beverage tool of claim 5 whereas said first barb is spaced distally from said second barb at a distal end of said post.

8. The beverage tool of claim 5 whereas said first barb and said second barb are wider medially at their base and narrower towards their point.

9. The beverage tool of claim 1 further comprising:
a thickened neck portion;
said thickened neck portion intermediate said rigid bottle opener and said post.

10. The beverage tool of claim 1 further comprising:
a relief at a medial intersection between said post and at least one of said first barb and said second barb.

11. The beverage tool of claim 1 further comprising:
a substantially flat portion of said inside wall of said oblong aperture whereas said substantially flat portion is opposed to said first tongue.

12. The beverage tool of claim 1 further comprising:
a first trademark flat with a trademark thereon positioned proximal to said oblong aperture of said rigid bottle opener.

13. The beverage tool of claim 1 further comprising:
a second trademark flat with a trademark thereon positioned distal to said oblong aperture of said rigid bottle opener.

14. The beverage tool of claim 1 further comprising:
a head housing of said bottle cap remover portion;
said head housing comprising a first body;
said head housing comprising a second body;
whereas said first body and said second body house a rigid bottle opener therebetween.

15. The beverage tool of claim 1 further comprising:
a leverage leg extending from said rigid bottle opener.

16. The beverage tool of claim 1 further comprising:
said first barb extending along an axis F1 to a point;
said second barb extending along an axis F2 to a point;
whereas said axis F1 and axis F2 are substantially parallel.

17. The beverage tool of claim 16 further whereas axis F1 and axis F2 are angled less than 45 degrees from a central axis of said post.

18. The beverage tool of claim 1 whereas said post terminates distally at a blunt end.

19. A method of using a beverage tool comprising the steps of:
obtaining a bottle containing solids debris;
obtaining a beverage tool;
securing the bottle with internal debris to be removed;
holding the bottle such that gravity moves the debris to the neck of the bottle;
inserting the post portion of the beverage tool in the mouth of the bottle;
moving the barbs of the beverage tool past at least a portion of the solid debris;
tilting the post portion such that barbs extending from the post engage the solid debris;
retracting the beverage tool thereby simultaneously removing the debris from the bottle;
removing the debris from the barb; and
disposing the debris.

20. The beverage tool of claim 1 whereas the thickness of said rigid bottle opener portion is substantially the same as the thickness of said post portion.
